(19) United States
(12) Patent Application Publication
(10) Pub. No.: US 2020/0302501 A1
(43) Pub. Date: Sep. 24, 2020

(54) VIRTUALIZED PRODUCT CONFIGURATION AND QUOTATION SYSTEM

(71) Applicant: Microsoft Technology Licensing, LLC, Redmond, WA (US)

(72) Inventor: Lijins Joseph, Hyderabad (IN)

(21) Appl. No.: 16/362,318

(22) Filed: Mar. 22, 2019

(51) Int. Cl. G06Q 30/06; G06T 19/20; G06F 3/01; G02B 27/01

(52) U.S. Cl. CPC G06Q 30/0621; G06T 19/20; G06Q 30/0611; G02B 27/017; G06F 3/011

(57) ABSTRACT

Systems and methods are provided for enabling configure, price, quote (CPQ) systems to generate visualizations of configurable products by displaying 3-dimensional virtual views of such objects on a head-mounted display (HMD) device. Users may interact with the displayed views by executing gestures recognized by the HMD device, the gestures corresponding to operations on the virtual view. Embodiments enable the user to add, modify or remove parts of the displayed virtual views of the configurable product. Embodiments may also permit rapid cycling through different configuration options through suitable gesture operations. Embodiments are configured to provide price information within the field of view including the displayed virtual view, the price information corresponding to the current configuration, and being updated as the user changes the active configuration.

### BACKGROUND

Configure, price, quote (CPQ) software solutions often fulfill a critical business process function whereby sellers employ CPQ systems to configure, price and quote configurable products for their customers. The value of a CPQ system becomes particularly apparent where the configurable products are complex and/or where the number of possible configurations is unwieldly. For example, suppose a customer is shopping for a new laptop computer. If the customer chooses a certain base model of computer (e.g., Dell Latitude 3000 series), the size of display screens may be limited. Then, given a certain choice of display screen size, a touch screen display may or may not be available. Likewise, the type and quantity of installable system memory may be constrained by the underlying motherboard. CPQ systems are typically quite capable of enumerating the various configurations, and calculating prices corresponding to each configuration.

Such systems, however, typically offer little means for providing rapid visualization of various configurations, offer little if any means for effectively visualizing the configuration options or illustrating how the product may physically vary from configuration to configuration, and may not simultaneous permit rapid determination of how configuration changes impact product price. For example, historically visualization has required drafting CAD drawings or the like. In many cases, however, such drawings may be of little use for verification and validation purposes, or where the configured products are intended to be placed in a particular physical location. Likewise, such drawings represent a static view of a particular configuration available at a particular time based on sub-components available at that time, and likewise capable of indicating the configuration price available at that time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and apparatuses are provided that address limitations of current configure, price, quote (CPQ) systems inasmuch as such systems are incapable of providing a virtual 3-dimensional visualization of a configurable product, particularly where the visualization includes dynamically updating price information as the configuration is modified.

In aspects, methods are provided that enable virtual configuration of a configurable object via a head-mounted display device. In one aspect, 3-dimensional (“3D”) models of the configurable object to be configured are received along with an initial configuration state for the configurable object, along with the price for an instance of the configurable object having the initial configuration. A 3D rendering of the configurable object along with the corresponding price is displayed in the forward field of view of a head-mounted display device, wherein the rendering reflects the received initial configuration state. Configuration changes are accepted for the configurable object, and the 3D rendering of the configurable object as displayed by the head-mounted display device is modified to reflect the received configuration change, and the displayed price corresponding to the modified configuration is likewise updated. A final configuration may be generated based upon the selection of a particular configuration, wherein the final configuration forms a basis for a price quote for a purchase of physical instances of the configurable object configured per the final configuration. In another aspect, the virtual images are rendered and displayed in the forward field of view of a head-mounted display device such that the virtual image is superimposed on an instance of the configurable object present in the physical environment visible in the forward field of view. In an aspect, configuration changes may be received by receiving gesture data from the head-mounted display device, or an associated input device, and identifying a configuration change based on an operation associated with a gesture corresponding to the received gesture data.

In one implementation, a virtualized configuration system includes a head-mounted display device, a model database including 3D models of a configurable object to be configured, a configuration database including configuration variations for the configurable object and further including corresponding pricing information, a configuration management component that exposes an application programming interface (API) configured to provide access to the model and configuration databases, and a virtualized configuration application component. In one aspect, the virtualized configuration application component is configured to receive via the API 3D models corresponding to the configurable object, and the initial configuration variation and price for the configurable object under configuration. The virtualized configuration application component may be further configured to render or cause to be rendered by the head-mounted display device a virtual image of the configurable object configured according to the initial configuration, where the virtual image likewise includes the price and the virtual image is superimposed on the forward field of view of the head-mounted display device.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts a virtualized configuration system, according to an embodiment.

FIG. 2 depicts a schematic view of a mixed reality configuration system, according to an embodiment.

FIG. 3 depicts an example head-mounted display device, according to an embodiment.

FIG. 4 depicts a functional diagram of example mixed reality head-mounted display optics, according to an embodiment.

FIG. 5 depicts a schematic view of a user wearing the head-mounted display device of FIG. 2 and viewing an example configuration environment, according to an embodiment.

FIG. 6 depicts the schematic view of FIG. 5 including mixed reality augmentation of the example configuration environment, according to an embodiment.

FIG. 7 depicts a flowchart of a method for virtual configuration of a configurable object via a head-mounted display device, according to embodiment.

FIG. 8 is a block diagram of an example computer system in which embodiments may be implemented.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. INTRODUCTION

The following detailed description discloses numerous embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner

### II. EXAMPLE EMBODIMENTS

The example embodiments described herein are provided for illustrative purposes and are not limiting. The examples described herein may be adapted to any type of CPQ system. Further structural and operational embodiments, including modifications/alterations, will become apparent to persons skilled in the relevant art(s) from the teachings herein.

Conventional CPQ systems are typically more than adequate for many configuration, pricing and quotation tasks, particularly when configurable products have only limited configuration options. In such instances, a typical process flow for generating a price quote may proceed as follows. First, a sales representative may call or otherwise communicate with a customer to receive a list of product requirements. Second, the sales representative may use the CPQ system to input the constraints imposed by the product requirements, and receive in turn a list of configurable products along with a list of specific configurations for each configurable product, and including price information for each. Finally, the sales representative may generate a price quote for one or more of the configurable products, and provide such quotes to the customer for consideration.

The above described process can certainly suffice where the configurable products have relatively few configurable options, or in situations where the specific physical features and/or aesthetics of the product are relatively unimportant. For example, some configurable products such as computer system memory DIMMs must ordinarily conform with tight dimensional specifications, and the aesthetics of such DIMMs is generally irrelevant owing to being wholly invisible inside a computer. In such a case, the inability of a conventional CPQ system to provide adequate visualization and manipulation capabilities may be unimportant.

For more complex configurable products, manual configuration may be difficult. Moreover, even where enumerating configuration alternatives may be relatively straightforward, it may be difficult for a customer to imagine what the final product looks like, or what it would look like in a particular location. Further, in situations where physical review or inspection of various configurations for a product would be preferable, it may not be feasible to do so as the number of configuration permutations grows.

To address the current shortcomings of CPQ systems, embodiments described herein are enabled to provide CPQ systems capable of producing configurable product visualizations by rendering on a display device virtual instances of configurable products. Embodiments may, for example, render such virtual instances as 3-dimensional (3D) views on a suitably equipped head-mounted display (HMD) device. Such rendered instances may, as discussed herein below, comprise or be incorporated into any of virtual reality (VR) content, augmented reality (AR) content, or mixed reality (MR) content.

Moreover, embodiments may permit interaction with the displayed virtual instances of the configurable products, whereby the user of the HMD device may provide gestures of one type or another for performing corresponding operations on the displayed virtual product. For example, such gestures may trigger rotation of the product, opening or closing parts, pushing buttons, turning wheels, or otherwise interacting with manipulable portions of the displayed instance and causing actions to be taken.

Likewise, embodiments may enable the user to add or remove optional parts of the displayed instance of the configurable product. Embodiments may also permit rapid cycling through different configuration options through suitable gesture operations. For example, embodiments may permit rapid visualization of different color options for the configurable product (or sub-portions thereof) by enabling the user to trigger a color change with a virtual “double tap” of the rendered configurable product.

Embodiments may also include price information within the rendered instance of the configurable product, wherein the price information corresponds to configuration being viewed and further wherein the displayed price information is updated in real-time as the user cycles through various configuration options for the configurable product.

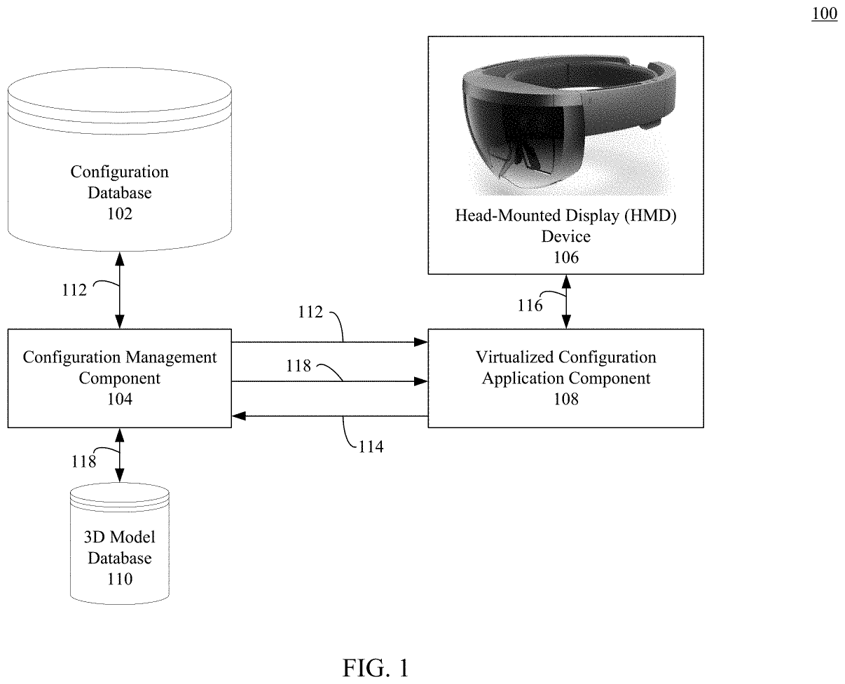

Enabling a CPQ system to allow users to perform the functions described herein above may be accomplished in numerous ways. For example, FIG. 1 depicts a virtualized configuration system 100, according to an embodiment. Virtualized configuration system 100 includes a configuration database 102, a configuration management component 104, a 3-dimentional (3D) model database 110, a virtualized configuration application component 108, and a head-mounted display device 106 (hereinafter “HMD display device”).

In embodiments, configuration database 102 is configured to store configuration data 112 which may comprise any data or metadata related to the available configurations for the available configurable products. Moreover, configuration data 112 also includes price information that comprises, or may be used at least in part to generate, the price for a particular configuration of a particular configurable product. As described in detail herein below, such configuration data 112 may be retrieved by configuration management component 104 in response to one or more requests 114 from virtualized configuration application component 108. In another embodiment, configuration data 112 may be pushed to virtualized configuration application component 108.

In embodiments, 3D model database 110 is configured to store 3D models 118 for each configurable product and/or 3D models for each configurable part or sub-portion of each configurable product. In embodiments, 3D models 118 enable virtualized configuration application component 108 and/or HMD display device 106 to render a 3D virtual instance of the chosen configurable product, and to thereafter modify or otherwise re-render the displayed instance of the configurable product. As described in detail herein below, such 3D models 118 may be retrieved by configuration management component 104 in response to one or more requests 114 from virtualized configuration application component 108. In another embodiment, 3D models 118 may be pushed to virtualized configuration application component 108.

Configuration database 102 and 3D model database 110 may each comprise any type of datastore that enables the storage and retrieval of their respective data according to one or more match criteria. For example, configuration database 102 and 3D model database 110 may each comprise a relational database system (e.g., MySQL), a graph database (e.g., Neo4j), a hierarchical database system (e.g., Jet Blue) or various types of file systems. Likewise, although depicted as a single database, configuration database 102 and 3D model database 110 may comprise one or more databases that may be organized in any manner both physically and virtually. In an embodiment, configuration database 102 and/or 3D model database 110 may comprise any number of servers, and may include any type and number of other resources, including resources that facilitate communications with and between the servers, and configuration management component 104, and any other necessary components. Servers of configuration database 102 and/or 3D model database 110 may be organized in any manner, including being grouped in server racks (e.g., 8-40 servers per rack, referred to as nodes or “blade servers”), server clusters (e.g., 2-64 servers, 4-8 racks, etc.), or datacenters (e.g., thousands of servers, hundreds of racks, dozens of clusters, etc.). In an embodiment, the servers of configuration database 102 and/or 3D model database 110 may be co-located (e.g., housed in one or more nearby buildings with associated components such as backup power supplies, redundant data communications, environmental controls, etc.) to form a datacenter, or may be arranged in other manners. Accordingly, in an embodiment, configuration database 102 and/or 3D model database 110 may comprise a datacenter in a distributed collection of datacenters.

In embodiments, configuration management component 104 is communicatively coupled to configuration database 102, 3D model database 110 and virtualized configuration application component 108 and may be configured to perform CPQ system functions. For example, configuration management component 104 may be configured to retrieve configuration data 112 and/or 3D models 118, and deliver the same to virtualized configuration application component 108 in response to system 100 being directed to render virtual instances of a particular configurable product. Although depicted as a monolithic component, configuration management component 104 may comprise any type and number of other resources, including resources that facilitate communications with and between the servers of configuration database 102 and/or 3D model database 110, and virtualized configuration application component 108, and any other necessary components. Moreover, embodiments of configuration management component 104 may be constituted, organized and co-located in any of the manners described herein above in relation to configuration database 102 and/or 3D model database 110.

In embodiments, and as discussed above, virtualized configuration application component 108 is configured to make requests 114 and receive 3D models 118 and configuration data 112 from configuration management component 104. Requests 114 may arise in conjunction with a user selecting a particular configurable product and/or configuration for visualization with HMD device 106. In embodiments, virtualized configuration application component 108 may be further configured to provide 3D models 118 and configuration data 112 to HMD device 106 for processing and display. Alternatively, virtualized configuration application component 108 may be configured to process 3D models 118 and configuration data 112 local to virtualized configuration application component 108, and then transfer displayable data directly to HMD device 106 via a suitable media interface (e.g., HDMI or DVI) for display. Of course, other structural and operational embodiments will be apparent to persons skilled in the relevant art(s).

HMD device 106 may comprise any type of head-mounted display device suitable for presenting 3D virtual reality, augmented reality or mixed reality content to the user. In embodiments, and as discussed in detail below, HMD device 106 may be enabled to detect gestures made by the user and communicate gesture data to virtualized configuration application component 108 for subsequent processing and action. For example, and as described above, embodiments of HMD device 106 may be enabled to capture video of the forward field of view of the HMD device, to process the video to detect and identify gestures (pre-defined motions with the hands or arms), and having detected gestures, to perform an operation on the rendered virtual image. Additionally or alternatively, user gestures may be detected by one or more user input devices (e.g., motion controllers, clickers, gamepads, or the like) used in conjunction with HMD device 106. More detailed aspects of embodiments are described herein below.

In an embodiment, configuration database 102 and/or 3D model database 110 and/or configuration management component 104 may be components in a pre-existing CPQ system, and virtualized configuration application component 108 is specifically adapted to use any existing methods of access to that CPQ system. In an alternative embodiment, however, configuration database 102 and 3D model database 110 may be components in an existing CPQ system, and configuration management component 104 serves as a glue layer between the CPQ system and virtualized configuration application component 108. For example, configuration management component 104 may expose an application programming interface (API) for consumption by virtualized configuration application component 108 for accessing CPQ databases. In this manner, configuration management component 104 serves to adapt different CPQ systems to the needs of virtualized configuration application component 108 without the need of virtualized configuration application component 108 having any knowledge of the underlying CPQ system.

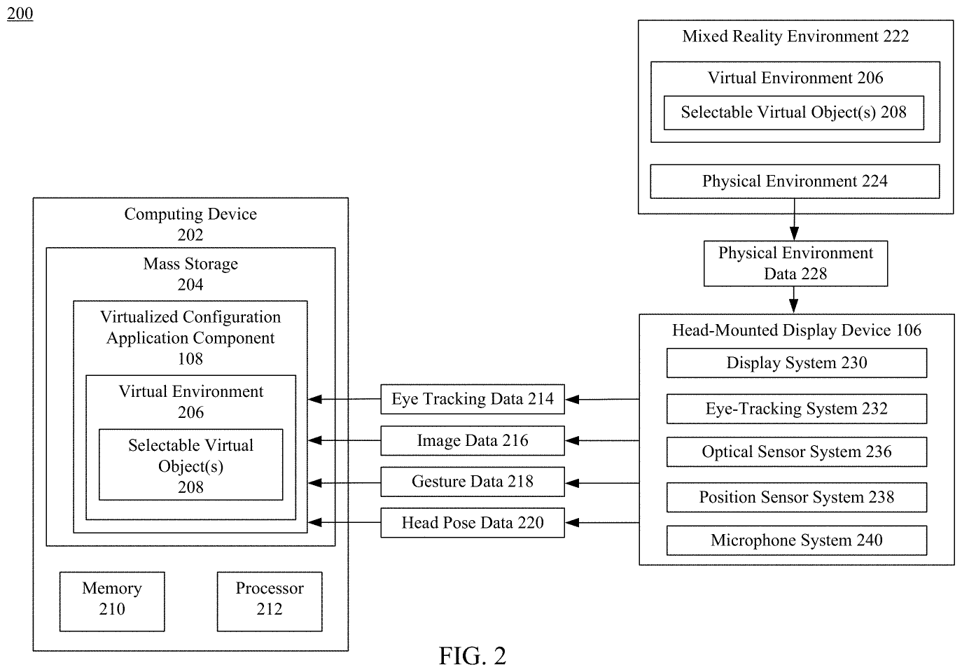

Further operational aspects of system 100 of FIG. 1 will now be discussed in conjunction with FIG. 2 which depicts a schematic view of a mixed reality configuration system 200, according to an embodiment. Although described with reference to system 100 of FIG. 1, mixed reality configuration system 200 is not limited to that implementation. Other structural and operational embodiments will be apparent to persons skilled in the relevant art(s) based on the following discussion regarding system 200 of FIG. 2.

FIG. 2 shows a schematic view of one embodiment of a mixed reality configuration system 200. Mixed reality configuration system 200 includes a computing device 202 and HMD device 106. Computing device 202 includes a mass storage 204, a memory 210 and a processor 212. Mass storage 204 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

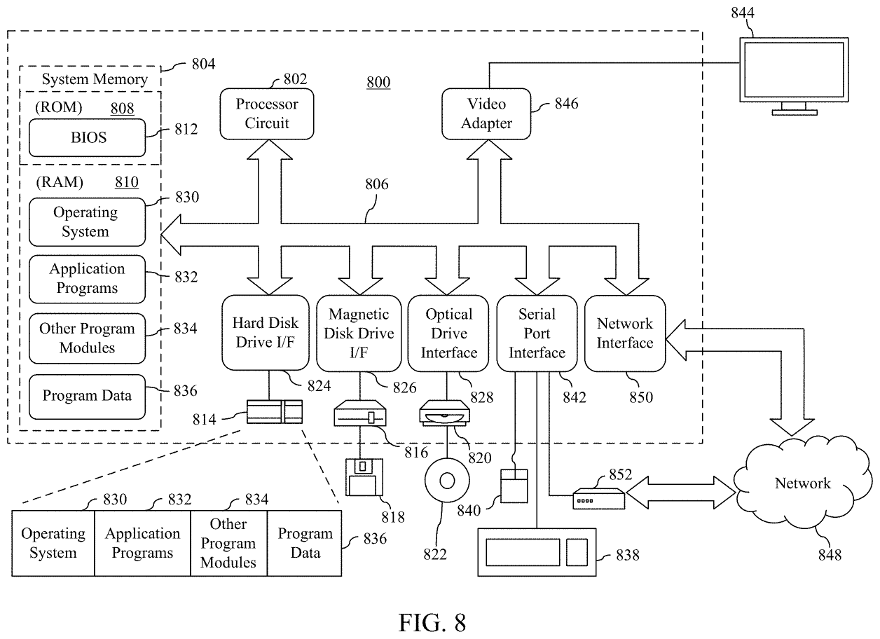

Computing device 202 may be any type of stationary or mobile computing device, including a mobile computer or mobile computing device (e.g., a Microsoft® Surface® device, a laptop computer, a notebook computer, a tablet computer such as an Apple iPad™, a netbook, etc.), home entertainment computer, interactive television, gaming system, or other suitable type of computing device. Additional details regarding the components and computing aspects of example computing devices are described in more detail below with reference to FIG. 8.

Furthermore, although computing device 202 and HMD device 106 may generally be described herein as separate devices, embodiments may combine computing device 202 and HMD device 106 into a single device such as, for example, a head-mounted device such as Microsoft HoloLens or so-called smart glasses such as Google® Glass™.

Mixed reality configuration system 200 includes a virtualized configuration application component 108 that may be stored in mass storage 204 of computing device 202, in an embodiment. Embodiments of virtualized configuration application component 108 may be loaded into memory 210 and executed by processor 212 of computing device 202 to perform one or more of the methods and processes described in more detail below.

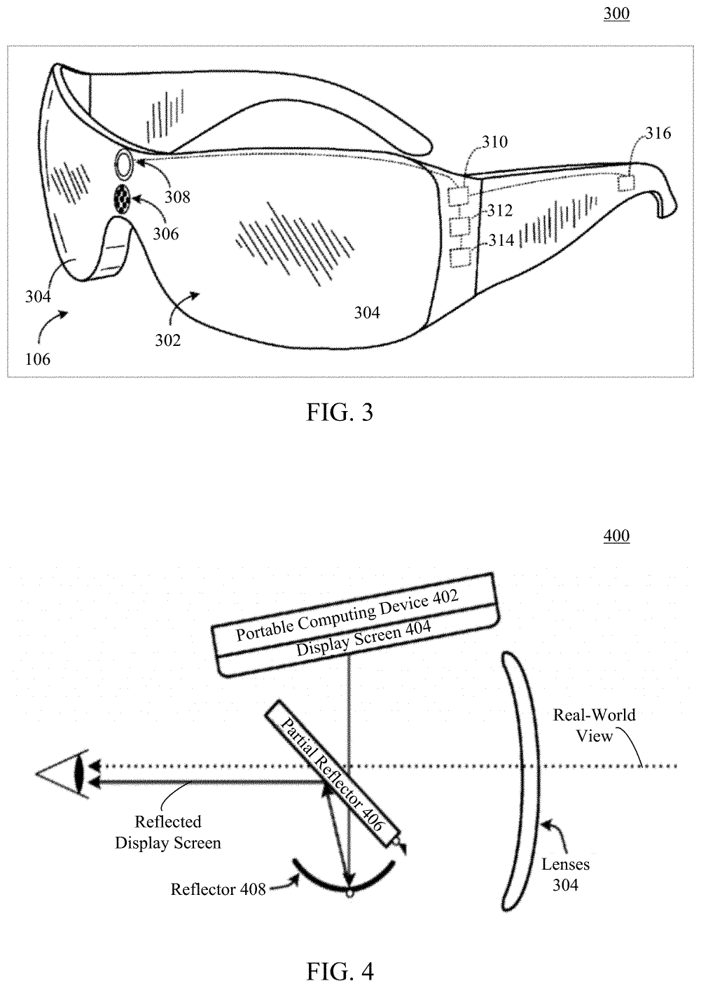

Virtualized configuration application component 108 may generate a virtual environment 206 for display on a display device, such as HMD device 106, to create a mixed reality environment 222. Virtual environment 206 includes one or more virtual images, such as two-dimensional virtual objects and three-dimensional holographic objects. In the present example, virtual environment 206 includes virtual objects in the form of selectable virtual objects 208. As described in more detail below with respect to FIG. 3, selectable virtual objects 208 may correspond to identifiable and/or manipulable targets that may be rendered by virtualized configuration application component 108 within the forward field of view of mixed reality environment 222. More specifically, virtual objects 208 may comprise a 3D rendering of a physical object. Alternatively, in embodiments, virtual objects 208 may also comprise a sub-portion of a rendered virtual object, and wherein the sub-portions may be manipulated independently of the entire virtual object. Virtual objects 208 may also comprise, and as will be discussed in greater detail below, a mixed reality virtual object rendered on HMD device 106 to modify the apparent appearance of a real, physical object visible within the forward field of view.

Computing device 202 may be operatively connected with HMD device 106 in a variety of ways. For example, computing device 202 and HMD device 106 may be connected with HMD device 106 via a wired connection such as, e.g., Ethernet, Universal Serial Bus (USB), DisplayPort, FireWire, and the like. Alternatively, computing device 202 and HMD device 106 may be operatively connected via a wireless connection. Examples of such connections may include, IEEE 802.11 wireless LAN (WLAN), Worldwide Interoperability for Microwave Access (Wi-MAX), cellular network, Bluetooth™, or near field communication (NFC). It should be understood, of course, that the abovementioned examples for coupling HMD device 106 with computing device 202 are applicable only in embodiments where computing device 202 and HMD device 106 are physically distinct devices.

Note also that the foregoing general description of the operation of system 200 is provided for illustration only, and embodiments of system 200 may comprise different hardware and/or software, and may operate in manners different than described above. Indeed, embodiments of system 200 may include various types of HMD display 106.

For example, and with continued reference to FIG. 2, FIG. 3 depicts an example HMD display device 106, according to an embodiment. In particular, HMD device 106 as shown in FIG. 3 takes the form of a pair of wearable glasses with a display 302. It will be appreciated that in other examples, and as will be discussed herein below, HMD device 106 may take other suitable forms in which a transparent, semi-transparent or non-transparent display is supported in front of a viewer's eye or eyes. Additionally, many other types and configurations of display devices having various form factors may also be used within the scope of the present disclosure. As discussed in more detail below, such display devices may include, but are not limited to, smart phones, tablet computers, and other suitable display devices.

Again, with reference to FIGS. 1 and 2, the example HMD device 106 of FIG. 3 includes display system 230 of FIG. 2 (not shown in FIG. 3), a display 302, lenses 304, an inward facing sensor 306, outward facing sensors 308, microphones 310, motion sensors 312, a processor 314 and speakers 316.

In embodiments, display system 230 and display 302 are configured to enable virtual images to be delivered to the eyes of a user in various ways. For example, display system 230 and display 302 may be configured to display virtual images that are wholly computer generated. This type of rendering and display is typically referred to as “virtual reality” since the visual experience is wholly synthetic and objects perceived in the virtual world are not related or connected to physical objects in the real world.

In another embodiment, display system 230 and display 302 may be configured to display virtual images that are a combination of images of the real, physical world, and computer-generated graphical content, and twhereby the appearance of the physical environment may be augmented by such graphical content. This type of rendering and display is typically referred to as “augmented reality.”

In still another embodiment, display system 230 and display 302 may also be configured to enable a user to view a physical, real-world object in physical environment 224. Physical environment 224 comprises all information and properties of the real-world environment corresponding to the forward field of view of HMD device 106, whether such information and properties are directly or indirectly perceived by the user. That is, physical environment 224 is sensed by the user and one or more cameras and/or sensors of the system, and none of physical environment 224 is created, simulated, or otherwise computer generated.

In an embodiment, a user may be enabled to view the physical environment while wearing HMD device 106 where, for example, display 302 includes one or more partially transparent pixels that are displaying a virtual object representation while simultaneously allowing light from real-world objects to pass through lenses 304 and be seen directly by the user. In one example, display 302 may include image-producing elements located within lenses 304 (such as, for example, a see-through Organic Light-Emitting Diode (OLED) display). Other means for combining computer images with real-world views will be discussed herein below regarding FIG. 4. This combination of real-world views and computer-generated graphics is usually referred to as “mixed reality.” It should be noted that although superficially similar, mixed reality and augmented reality differ in that physical, real-world objects are directly viewed. In augmented reality, on the other hand, although the user perceives a view of the real world, the view is not being directly perceived by the user, but instead is typically a captured view of the real world. For example, although photos and videos of the real world may be augmented with computer graphics and displayed, the real-world objects in the photos and videos are not directly perceived, only the augmented reproduction.

Embodiments of HMD device 106 may also include various sensors and related systems. For example, HMD device 106 may include an eye-tracking sensor system (not shown in FIG. 3) that utilizes at least one inward facing sensor 306. Inward facing sensor 306 may be an image sensor that is configured to acquire image data in the form of eye-tracking information from a user's eyes. Provided the user has consented to the acquisition and use of this information, the eye-tracking sensor system may use this information to track a position and/or movement of the user's eyes.

In one example, an eye-tracking system 232 of HMD device 106 may include a gaze detection subsystem configured to detect a direction of gaze of each eye of a user. The gaze detection subsystem may be configured to determine gaze directions of each of a user's eyes in any suitable manner. For example, the gaze detection subsystem may comprise one or more light sources, such as infrared light sources, configured to cause a glint of light to reflect from the cornea of each eye of a user. One or more image sensors may then be configured to capture an image of the user's eyes. Images of the glints and of the pupils as determined from image data gathered from the image sensors may be used to determine an optical axis of each eye. Using this information, an eye-tracking sensor system may then determine a direction and/or at what physical object or virtual object the user is gazing. Captured or derived eye-tracking data may then be provided to virtualized configuration application component 108 as eye tracking data 214 as shown in FIG. 2. It should be understood that a gaze detection subsystem may have any suitable number and arrangement of light sources and image sensors.

HMD device 106 may also include sensor systems that receive physical environment data 228 from physical environment 224. For example, HMD device 106 may include optical sensor system 236 of FIG. 2 that utilizes at least one of outward facing sensors 308, such as an optical sensor (i.e., a camera sensor). Outward facing sensors 308 may also capture two-dimensional image information and depth information from a physical environment and physical objects within the environment. For example, outward facing sensors 308 may include a depth camera, a visible light camera, an infrared light camera, and/or a position tracking camera, in embodiments.

Outward facing sensors 308 of HMD device 106 may also provide depth sensing image data via one or more depth cameras. In one example, each depth camera may include left and right cameras of a stereoscopic vision system. Time-resolved images from one or more of these depth cameras may be provided, for example, to virtualized configuration application component 108 as image data 216 for further processing. For example, such images included in image data 216 may be registered to each other and/or to images from another optical sensor such as a visible spectrum camera, and then combined to yield depth-resolved video.

In other examples a structured light depth camera may be configured to project a structured infrared illumination, and to image the illumination reflected from a scene onto which the illumination is projected. The captured images may likewise be provided to virtualized configuration application component 108 as image data 216 for construction of a depth map of the scene based on spacings between adjacent features in the various regions of an imaged scene. In still other examples, a depth camera may take the form of a time-of-flight depth camera configured to project a pulsed infrared illumination onto a scene and detect the illumination reflected from the scene. It will be appreciated that any other suitable depth camera may be used within the scope of the present disclosure.

Outward facing sensors 308 may detect movements within its field of view, such as gesture-based inputs or other movements performed by a user or by a person or physical object within the forward field of view. For example, outward facing sensors 308 may capture images as described above, determine that motion detectable within some portion of the captured image may match one or more pre-defined gesture definitions, and provide gesture-related information to virtualized configuration application component 108 as gesture data 218. Gesture data 218 may comprise the gesture-related images captured by outward facing sensors 308, depth information of gesture targets, image coordinates defining the gesture target, and the like as understood by those skilled in the relevant art(s). Gesture data 218 may then be analyzed or processed, alone or in combination with image data 216, by virtualized configuration application component 108 to identify the gesture and the corresponding operation to perform.

Outward facing sensors 308 may capture images of physical environment 224 in which a user is situated. As discussed in more detail below, such images may be part of physical environment data 228 that is received by HMD device 106 and provided to computing device 202 of FIG. 2. In one example, virtualized configuration application component 108 may include a 3D modeling system that uses such input to generate virtual environment 206 that models physical environment data 228 that is captured and/or combines generated virtual images included in the virtual environment 206 with the captured images of physical environment 224.

HMD device 106 may also include a position sensor system 238 of FIG. 2 that utilizes one or more motion sensors 312 to enable position tracking and/or orientation sensing of the HMD device. For example, position sensor system 238 may be utilized to determine a head pose orientation of a user's head. In one example, position sensor system 238 may comprise an inertial measurement unit configured as a six-axis or six-degree of freedom position sensor system. This example position sensor system may, for example, include three accelerometers and three gyroscopes to indicate or measure a change in location of HMD device 106 within three-dimensional space along three orthogonal axes (e.g., x, y, z), and a change in an orientation of the HMD device about the three orthogonal axes (e.g., roll, pitch, yaw).

In some examples, motion sensors 312 may also be employed as user input devices, such that a user may interact with HMD device 106 via gestures of the neck and head, or even of the body. HMD device 106 may also include a microphone system 240 of FIG. 2 that includes one or more microphones 310. In other examples, audio may be presented to the user via one or more speakers 316 on HMD device 106.

HMD device 106 may also include a processor 314 having a logic subsystem and a storage subsystem, as discussed in more detail below with respect to FIG. 8, that are in communication with the various sensors and systems of the HMD device. In one example, the storage subsystem may include instructions that are executable by the logic subsystem to receive signal inputs from the sensors and forward such inputs to computing device 202 (in unprocessed or processed form), and to present images to a user via display 302.

It will be appreciated that HMD device 106 and related sensors and other components described above and illustrated in FIGS. 2 and 3 are provided by way of example. These examples are not intended to be limiting in any manner, as any other suitable sensors, components, and/or combination of sensors and components may be utilized. Therefore it is to be understood that HMD device 106 may include additional and/or alternative sensors, cameras, microphones, input devices, output devices, etc. without departing from the scope of this disclosure. Further, the physical configuration of HMD device 106 and its various sensors and subcomponents may take a variety of different forms without departing from scope of this disclosure.

FIG. 4 depicts a functional diagram 400 of example mixed reality head-mounted display optics, according to an embodiment. Note that for purposes of clarity, FIG. 4 does not depict several of the various components already described with respect to FIGS. 2 and 3 (e.g., display system 320, sub-components of HMD device 106 or virtualized configuration application component 108). However, the functionality of these components, similar to the functionality described with respect to FIGS. 2 and 3, may be adapted for use with the optical components illustrated by FIG. 4.

For example, as depicted by FIG. 4, embodiments of HMD device 106 may include a portable computing device 402 having a display screen 404 on which virtual content is being rendered. Portable computing device 402, and thus display screen 404, is coupled to HMD device 106 by an attachment mechanism (not shown) that exposes the display screen to a partial reflector 406. Light emitted from display screen 404 (e.g., mixed reality content to be overlaid on the view physical environment) passes through partial reflector 406 to a reflector 408. As illustrated by the arrows showing light reflection paths in FIG. 4, reflector 408 is configured to reflect light received through partial reflector 406 back towards partial reflector 406 where that light is then further reflected towards the user's eyes. Concurrently, light from the real-world environment perceivable in the forward field of view of HMD device 106 passes through lenses 304 as described above, and then passes directly through partial reflector 406 to provide a real-world view to the user's eyes.

As with embodiments described above in relation to FIGS. 2 and 3, in the example of FIG. 4, in the case that lenses 304 are fully transparent, any content presented on the display screen 404 will be perceived by the user as mixed reality content that appears to exist within the real world because the user will concurrently see both the mixed reality content and a real world view through the front transparent optical member. Conversely, in the case that lenses 304 are fully opaque, any content presented on display screen 404 will be perceived by the user as virtual reality content since the user will be unable to see a real-world view through the fully opaque front transparent optical member. Lastly, in the case that lenses 304 are fully opaque, and portable computing device 402 is configured to capture images or video of the forward field of view of HMD device 106 through a camera sensor (not shown), portable computing device 402 may be configured to display mixed reality content, i.e., the combination a virtual content and captured images of the physical environment.

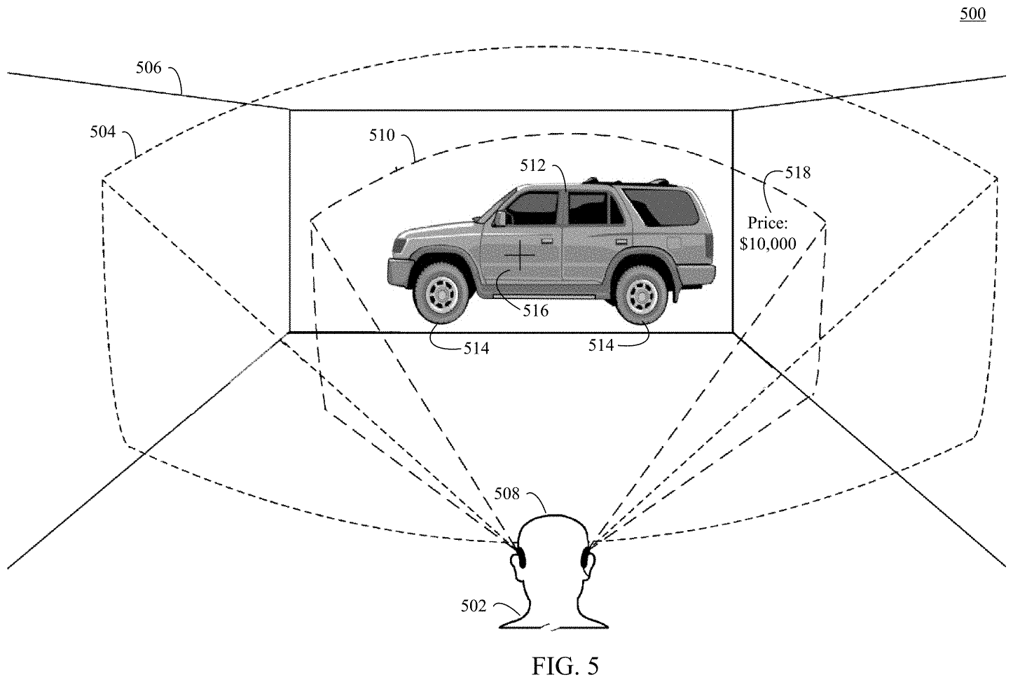

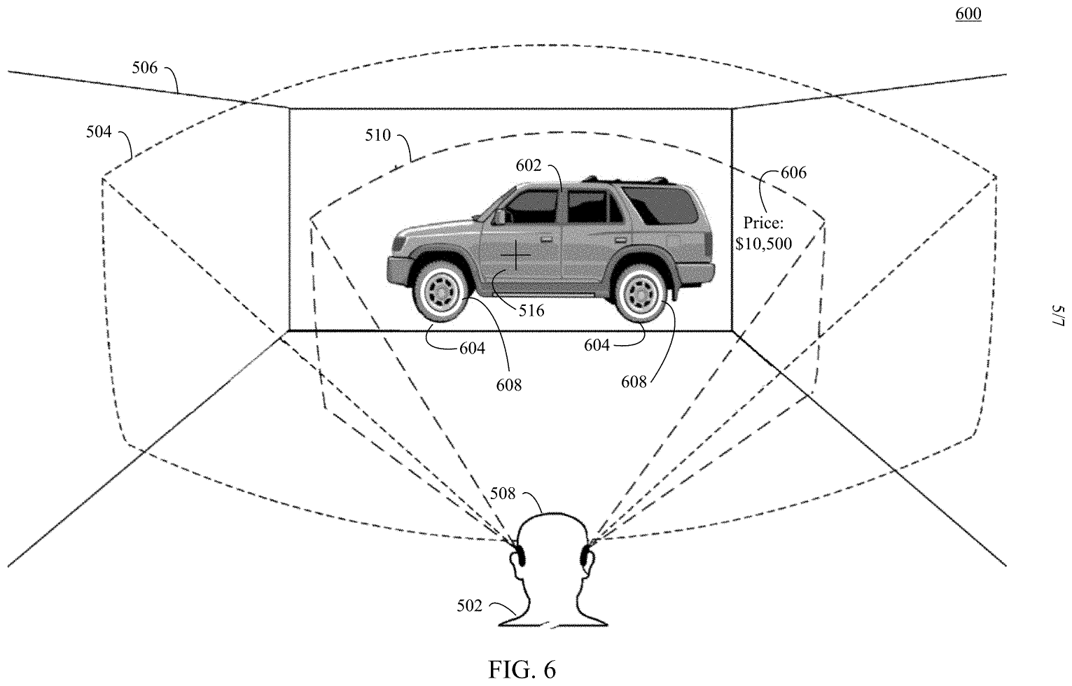

FIG. 5 depicts a schematic view 500 of a user 502 wearing HMD device 106 of FIG. 2 and viewing an example mixed reality environment 222, according to an embodiment. With continued reference to mixed reality configuration system 200 of FIG. 2, and as viewed by user 502, physical environment 224 combines with the virtual environment 206 to create the mixed reality environment 222 in room 506. As shown in FIG. 5, the mixed reality environment 222 occupies spatial region 504 of physical environment 224 that represents a portion of room 506 viewable through the HMD device 106, and thus the portion of room 506 that may be augmented with virtual images displayed via HMD device 106. In this example, room 506 has been augmented with virtual images of a car 512 corresponding to a chosen configuration, and configuration price 518 that corresponds to the chosen configuration. In some embodiments, spatial region 504 may be substantially coextensive with the user's actual field of vision, while in other embodiments spatial region 504 may occupy a lesser portion of the user's actual field of vision.

Using head pose data 220 received from the position sensor system 238, embodiments of virtualized configuration application component 108 may determine an orientation of the user's head 508 with respect to physical environment 224 and spatial region 504. Virtualized configuration application component 108 then defines a sub-region 510 within spatial region 504 that corresponds generally to the forward field of view of HMD device 106 (i.e., the direction user 502 is facing). Given that user 502 is facing sub-region 510, this sub-region may correspond to the portion of spatial region 504 in which user 502 is currently interested. It also follows that the user's attention may be focused on one or more physical and/or virtual objects in sub-region 510. As shown in FIG. 5, sub-region 510 occupies a smaller volume of the physical environment 224 than spatial region 504. It will also be appreciated that the sub-region 510 may have any suitable shape that captures a portion of spatial region 504 toward which user 502 is generally facing.

One or more virtual objects in sub-region 510 may be selectable by user 502 via the HMD device 106. Accordingly, the virtualized configuration application component 108 may be configured to generally identify the selectable objects within the sub-region 510, whether virtual or physical, as gross selectable targets.

In this example, the gross selectable targets include a selectable virtual object in the form of car 512. In other examples two or more selectable virtual objects may be identified within a sub-region. For example, tires 514 of car 512 are also gross selectable targets. For purposes of this disclosure, “selectable” means that one or more operations may be performed on the object. Examples of such operations include, but are not limited to, selecting a portion of a configurable object to re-configure, to change a property of any such objects, launching an application via the object, displaying a menu of operations and/or other actions related to the object, performing word processing operations related to the object, searching operations, browsing operations, image capture operations, altering the display of the object, etc.

It will also be appreciated that as the user's head 508 moves, spatial region 504 and sub-region 510 correspondingly move and may capture other objects within their fields of view. For example, as the user's head 508 rotates to the left, the sub-region 510 may capture objects that were inside spatial region 504, but were outside sub-region 510.

Using eye-tracking data 214, the virtualized configuration application component 108 may more specifically identify selectable target from among the gross selectable targets at which user 502 is gazing. In the present example and with reference also to FIG. 4, the virtualized configuration application component 108 may use eye-tracking data 214 to identify a focal point 516 of the user's gaze. Using focal point 516, virtualized configuration application component 108 may determine that the user is gazing at car 512. In an embodiment, focal point 516 may not be visible to user 502.

FIG. 6 depicts a schematic view 600 including mixed reality augmentation of the example configuration environment of FIG. 5, according to an embodiment. With reference to FIG. 5, and as described above, sub-region 510 of FIG. 5 includes virtual object car 512 displayed by HMD device 106 overlaid on the view of room 506. FIG. 6, on the other hand, depicts car 602 which should be understood in this example to represent a physical, real-world instance of a car that is present within room 506, and wherein car 602 has the same configuration as that of car 512. Schematic view 600 is otherwise mostly identical to schematic view 500, but with two exceptions. First, tires 604 (which are physical real-world tires on car 602) include augmentation 608 comprising white circles to cause tires 604 to appear as whitewall tires. That is, car 602 combined with the augmentation 608 depicts a different configuration for this model of vehicle. Second, price 606 now reflects the higher cost of this configuration cause by the inclusion of white wall tires.

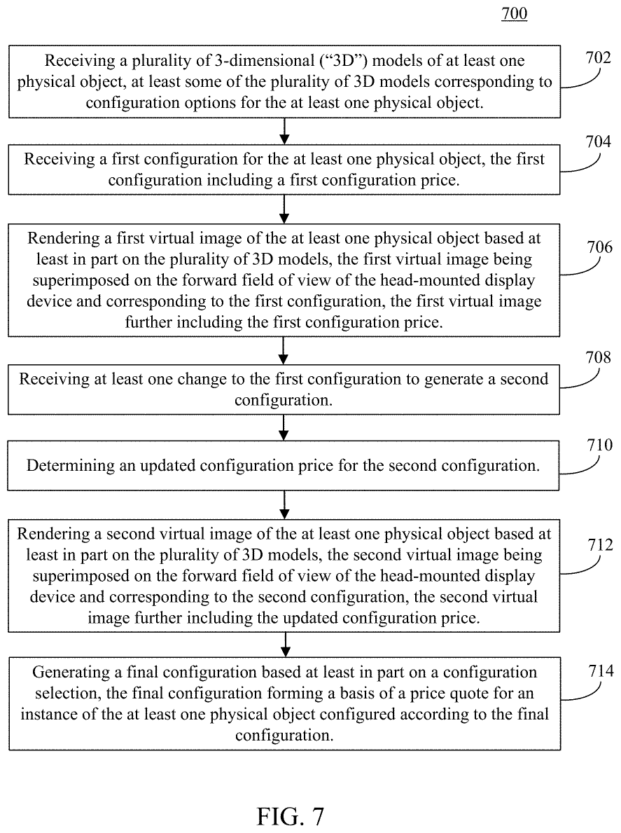

In embodiments, systems 100 and/or 200 of FIGS. 1 and 2, respectively, may be used in various ways to perform configuration of configurable products. For instance, FIG. 7 depicts a flowchart 700 of a method for virtual configuration of a configurable object via a head-mounted display device, according to an example embodiment of virtualized configuration system 100. Flowchart 700 is described with continued reference to FIG. 1. However, other structural and operational embodiments will be apparent to persons skilled in the relevant art(s) based on the following discussion regarding flowchart 700 and virtualized configuration system 100 of FIG. 1.

Flowchart 700 begins at step 702. At step 702, a plurality of 3-dimensional (“3D”) models of at least one physical object is received, at least some of the plurality of 3D models corresponding to configuration options for the at least one physical object. For example, and with reference to system 100 of FIG. 1, each of configuration management component 104 and virtualized configuration application component 108 may, as discussed above, be configured to receive 3D models 118. In embodiments, and as described in detail above, configuration management component 104 is configured to receive 3D models 118 from 3D model database 110, and configuration management component 104 in turn passes 3D models 118 to virtualized configuration application component 108 where it is received.

Flowchart 700 of FIG. 7 continues at step 704. In step 704, a first configuration for the at least one physical object is received, the first configuration including a first configuration price. For example, and with reference to system 100 of FIG. 1, each of configuration management component 104 and virtualized configuration application component 108 may, as discussed above, be configured to receive configuration data 112. In embodiments, and as described in detail above, configuration management component 104 is configured to receive configuration data 112 from configuration database 102, and configuration management component 104 in turn passes configuration data 112 to virtualized configuration application component 108 where it is received.

In step 706, a first virtual image of the at least one physical object is rendered based at least in part on the plurality of 3D models, the first virtual image being superimposed on the forward field of view of the head-mounted display device and corresponding to the first configuration, the first virtual image further including the first configuration price. For example, and with continued reference to system 100 of FIG. 1, virtualized configuration application component 108, HMD display 106 each may be configured to render a virtual image of the object being configured, and based on 3D models 118 and configuration data 112.

In an embodiment, the first virtual image may comprise a rendering of the at least one physical object itself. It is naturally the case in such a situation that the virtual image is more or less wholly derived from the 3D models, and will be rendered as a 3D holographic virtual image.

In another embodiment, however, the first virtual image may comprise mixed reality content, e.g., an overlay image rendered over a physical instance of the at least one physical object present in the forward field of view of HMD display 106. In this instance, the 3D models corresponding to the physical object may be primarily used to determine placement of the overlay image depending on the exact nature of the overlay image. For example, an overlay image could comprise text or graphics intended to change the apparent appearance of the physical object viewable in the forward field of view, in which case the first virtual image comprises a two-dimensional virtual image.

In step 708, at least one change to the first configuration is received to generate a second configuration. For example, and with continued reference to system 100 of FIG. 1, virtualized configuration application component 108 may be configured to receive a change to the initial configuration via, for example, an input device associated with virtualized configuration application component 108 (e.g., a console keyboard), in an embodiment. In another embodiment, and as described in detail above, HMD device 106 may be configured to detect and identify various types of gestures, wherein a gesture may correspond to a change command (e.g., a “double tap” on the virtual image cycles to the next color option of the configuration). In this manner, embodiments may receive configuration changed interactively via gestures to quickly visualize configuration changes and corresponding price changes.

Flowchart 700 continues at step 710. In step 710, an updated configuration price for the second configuration is determined. For example as discussed above, and with continued reference to system 100 of FIG. 1, either of virtualized configuration application component 108 and HMD device 106 may be configured to determine a new price for the changed configuration.

In step 712, a second virtual image of the at least one physical object is rendered based at least in part on the plurality of 3D models, the second virtual image being superimposed on the forward field of view of the head-mounted display device and corresponding to the second configuration, the second virtual image further including the updated configuration price. For example, and with continued reference to system 100 of FIG. 1, virtualized configuration application component 108, HMD display 106 each may be configured to render a virtual image of the object being configured, and based on 3D models 118 and configuration data 112.

Flowchart 700 of FIG. 7 concludes at step 714. In step 714, a final configuration is generated based at least in part on a configuration selection, the final configuration forming a basis of a price quote for an instance of the at least one physical object configured according to the final configuration. For example as discussed above, and with continued reference to system 100 of FIG. 1, configuration management component 104 may be configured to accept a final configuration selection from an input method local to either of configuration management component 104 or virtualized configuration application component 108 (e.g., a console keyboard), or from HMD display 106 via gesture, voice or other means of input included on embodiments of HMD display 106.

In the foregoing discussion of steps 702-714 of flowchart 700, it should be understood that at times, such steps may be performed in a different order or even contemporaneously with other steps. For example, steps 702 and 704, respectively, may be performed in a different order or even simultaneously. Other operational embodiments will be apparent to persons skilled in the relevant art(s). Note also that the foregoing general description of the operation of system 100 is provided for illustration only, and embodiments of system 100 may comprise different hardware and/or software, and may operate in manners different than described above.

The embodiments described herein above provide improvements to computer-based CPQ systems in a number of ways. For example, the abovementioned interactive visualization functions provide a much improved graphical user interface (GUI). Likewise, centralized storage of 3D models in a centrally-accessible database and allowing them to be accessed by different HMD devices (via a common API), not only improves the functioning and resource usage of the HMD device, which need not store the models locally, but also improves the functioning and resource usage of the system as a whole since numerous duplicate copies of 3D models are not required at the site of each HMD device which relieves the system of needing to distribute the models, as well as keeping all such copies in sync when changes to the models are made.

### III. EXAMPLE COMPUTER SYSTEM IMPLEMENTATION

Each of configuration database 102, configuration management component 104, model database 110, virtualized configuration application component 108 and/or head-mounted display 106, and flowchart 700 may be implemented in hardware, or hardware combined with software and/or firmware. For example, configuration database 102, configuration management component 104, model database 110, virtualized configuration application component 108 and/or head-mounted display 106, and flowchart 700 may be implemented as computer program code/instructions configured to be executed in one or more processors and stored in a computer readable storage medium. Alternatively, configuration database 102, configuration management component 104, model database 110, virtualized configuration application component 108 and/or head-mounted display 106, and flowchart 700 may be implemented as hardware logic/electrical circuitry.

For instance, in an embodiment, one or more, in any combination, of configuration database 102, configuration management component 104, model database 110, virtualized configuration application component 108 and/or head-mounted display 106, and flowchart 700 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 8 depicts an exemplary implementation of a computing device 800 in which embodiments may be implemented. For example, configuration database 102, configuration management component 104, model database 110, virtualized configuration application component 108 and/or head-mounted display 106 may each be implemented in one or more computing devices similar to computing device 800 in stationary or mobile computer embodiments, including one or more features of computing device 800 and/or alternative features. The description of computing device 800 provided herein is provided for purposes of illustration, and is not intended to be limiting. Embodiments may be implemented in further types of computer systems, as would be known to persons skilled in the relevant art(s).

As shown in FIG. 8, computing device 800 includes one or more processors, referred to as processor circuit 802, a system memory 804, and a bus 806 that couples various system components including system memory 804 to processor circuit 802. Processor circuit 802 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 802 may execute program code stored in a computer readable medium, such as program code of operating system 830, application programs 832, other programs 834, etc. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computing device 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 830, one or more application programs 832, other programs 834, and program data 836. Application programs 832 or other programs 834 may include, for example, computer program logic (e.g., computer program code or instructions) for implementing configuration database 102, configuration management component 104, model database 110, virtualized configuration application component 108 and/or head-mounted display 106, and flowcharts flowchart 700 (including any suitable step of flowchart 700), and/or further embodiments described herein.

A user may enter commands and information into the computing device 800 through input devices such as keyboard 838 and pointing device 840. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 802 through a serial port interface 842 that is coupled to bus 806, but may be connected by other interfaces, such as a parallel port, game port, or a universal serial bus (USB).

A display screen 844 is also connected to bus 806 via an interface, such as a video adapter 846. Display screen 844 may be external to, or incorporated in computing device 800. Display screen 844 may display information, as well as being a user interface for receiving user commands and/or other information (e.g., by touch, finger gestures, virtual keyboard, etc.). In addition to display screen 844, computing device 800 may include other peripheral output devices (not shown) such as speakers and printers.

Computing device 800 is connected to a network 848 (e.g., the Internet) through an adaptor or network interface 850, a modem 852, or other means for establishing communications over the network. Modem 852, which may be internal or external, may be connected to bus 806 via serial port interface 842, as shown in FIG. 8, or may be connected to bus 806 using another interface type, including a parallel interface.

As used herein, the terms “computer program medium,” “computer-readable medium,” and “computer-readable storage medium” are used to refer to physical hardware media such as the hard disk associated with hard disk drive 814, removable magnetic disk 818, removable optical disk 822, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 832 and other programs 834) may be stored on the hard disk, magnetic disk, optical disk, ROM, RAM, or other hardware storage medium. Such computer programs may also be received via network interface 850, serial port interface 842, or any other interface type. Such computer programs, when executed or loaded by an application, enable computing device 800 to implement features of embodiments described herein. Accordingly, such computer programs represent controllers of the computing device 800.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. ADDITIONAL EXAMPLE EMBODIMENTS

A method for virtual configuration of at least one physical object via a head-mounted display device including a plurality of sensors and a forward field of view is described herein. The method includes: receiving a plurality of 3-dimensional (“3D”) models of the at least one physical object, at least some of the plurality of 3D models corresponding to configuration options for the at least one physical object; receiving a first configuration for the at least one physical object, the first configuration including a first configuration price; rendering a first virtual image of the at least one physical object based at least in part on the plurality of 3D models, the first virtual image being superimposed on the forward field of view of the head-mounted display device and corresponding to the first configuration, the first virtual image further including the first configuration price; receiving at least one change to the first configuration to generate a second configuration; determining an updated configuration price for the second configuration; rendering a second virtual image of the at least one physical object based at least in part on the plurality of 3D models, the second virtual image being superimposed on the forward field of view of the head-mounted display device and corresponding to the second configuration, the second virtual image further including the updated configuration price; and generating a final configuration based at least in part on a configuration selection, the final configuration forming a basis of a price quote for an instance of the at least one physical object configured according to the final configuration.

In another embodiment of the foregoing method, each of the first virtual image and the second virtual image is rendered as one of a two-dimensional virtual image or a three-dimensional holographic virtual image.

In another embodiment of the foregoing method, the first and second virtual images are superimposed on an instance of the at least one physical object present within the forward field of view of the head-mounted display device, thereby changing an apparent appearance of the instance of the at least one physical object.

One embodiment of the foregoing method further comprises interactively receiving a plurality of changes to the first configuration; and for each of the plurality of changes to the first configuration, rendering an updated virtual image reflecting the respective one of the plurality of changes, the updated virtual image including an updated configuration price.

In another embodiment of the foregoing method, interactively receiving a plurality of changes to the first configuration comprises: receiving gesture data from the head-mounted display device or an input device associated therewith; and identifying at least one of the plurality of changes to the first configuration based at least in part on an operation associated with a gesture corresponding to the gesture data.

In another embodiment of the foregoing method, the plurality of 3D models is received from a configure, price, quote (CPQ) system.

In another embodiment of the foregoing method, determining an updated configuration price for the second configuration comprises: providing at least part of the second configuration to the CPQ system; and receiving the updated configuration price from the CPQ system, the updated configuration price based at least in part on the second configuration.

A virtualized configuration system is described herein. The system comprises a head-mounted display device configured to provide a view of a virtual environment including at least one virtual image, the head-mounted display device including a plurality of sensors and a forward field of view; a model database including a plurality of 3-dimensional (3D) models of at least one configurable physical object; a configuration database including a plurality of configuration variations for the at least one configurable physical object, each of the plurality of configuration variations including pricing data for determining a price quote for an instance of the at least one configurable physical object that includes one or more of the plurality of configuration variations; a configuration management component that comprises a virtualized configuration application programming interface (API) configured to provide access to the 3D models of the model database and the configuration variations of the configuration database; and a virtualized configuration application component configured to: receive via the virtualized configuration API the plurality of 3D models corresponding to the at least one configurable physical object; receive via the virtualized configuration API a first configuration variation for the at least one configurable physical object, the first configuration variation including a first configuration price; and render in the head-mounted display device a first virtual image of the at least one configurable physical object based at least in part on the plurality of 3D models corresponding to the first configuration variation, the first virtual image being superimposed on the forward field of view and including the first configuration price.

In one embodiment of the foregoing system, wherein the configuration management component is further configured to generate a final configuration based at least in part on a final configuration selection, the final configuration forming a basis of a price quote for an instance of the at least one configurable physical object configured according to the final configuration.

In one embodiment of the foregoing system, the virtualized configuration application component is configured to interactively receive the at least one change to the first configuration variation by: receiving gesture data from the head-mounted display device or an input device associated therewith; identifying a gesture based at least in part on the gesture data; and identifying the at least one change to the first configuration variation based at least in part on an operation associated with the identified gesture.

In one embodiment of the foregoing system, the virtualized configuration application component is configured to interactively receive the at least one change to the first configuration variation by: receiving gesture data from the head-mounted display device or an input device associated therewith; identifying a gesture based at least in part on the gesture data; and identifying the at least one change to the first configuration variation based at least in part on an operation associated with the identified gesture.

In one embodiment of the foregoing system, the first virtual image and the updated virtual image are superimposed on an instance of the at least one configurable physical object present within a physical environment visible in the forward field of view, thereby changing an apparent appearance of the instance of the at least one configurable physical object.

In one embodiment of the foregoing system, the first virtual image and the updated virtual image are each rendered as one of a two-dimensional virtual image or a three-dimensional holographic virtual image.

A head-mounted display device for virtual configuration of at least one physical object is described herein. The head-mounted display device comprising: a display system including at least one display component configured to display virtual image content in a forward field of view; a plurality of sensors; one or more processors; and one or more computer-readable storage media having stored thereon instructions, the instructions configured to, when executed by the one or more processors, cause the one or more processors to: receive a plurality of 3-dimensional (“3D”) models of the at least one physical object, at least some of the plurality of 3D models corresponding to configuration options for the at least one physical object; receive a first configuration for the at least one physical object, the first configuration including a first configuration price; render on the at least one display component of the display system a first virtual image of the at least one physical object based at least in part on the plurality of 3D models, the first virtual image being superimposed on the forward field of view and corresponding to the first configuration, the first virtual image further including the first configuration price; receive at least one change to the first configuration to generate a second configuration; determine an updated configuration price for the second configuration; render on the at least one display component of the display system a second virtual image of the at least one physical object based at least in part on the plurality of 3D models, the second virtual image being superimposed on the forward field of view and corresponding to the second configuration, the second virtual image further including the updated configuration price; and generate a final configuration based at least in part on a configuration selection, the final configuration forming a basis of a price quote for an instance of the at least one physical object configured according to the final configuration.

In one embodiment of the foregoing head-mounted display device the instructions are further configured to render each of the first and second virtual images as one of a two-dimensional virtual image or a three-dimensional holographic virtual image.

In one embodiment of the foregoing head-mounted display device the instructions are further configured to, when executed by the one or more processors, cause the one or more processors to superimpose the first and second virtual images on an instance of the at least one physical object present within the forward field of view of the head-mounted display device, thereby changing an apparent appearance of the instance of the at least one physical object.

In one embodiment of the foregoing head-mounted display device the instructions are further configured to, when executed by the one or more processors, cause the one or more processors to: interactively receive a plurality of changes to the first configuration; and for each of the plurality of changes to the first configuration, render an updated virtual image reflecting the respective one of the plurality of changes, the updated virtual image including an updated configuration price.

In one embodiment of the foregoing head-mounted display device the instructions are configured to, when executed by the one or more processors, cause the one or more processors to interactively receive the plurality of changes to the first configuration by: receiving gesture data from the head-mounted display device or an input device associated therewith; identifying a gesture based at least in part on the gesture data; and identifying at least one of the plurality of changes to the first configuration based at least in part on an operation associated with the identified gesture.

In one embodiment of the foregoing head-mounted display device the plurality of 3D models is received from a configure, price, quote (CPQ) system.

In one embodiment of the foregoing head-mounted display device determining an updated configuration price for the second configuration comprises receiving the updated configuration price from the CPQ system, the updated configuration price based at least in part on the second configuration.

### V. CONCLUSION

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. A method for virtual configuration of at least one physical object via a head-mounted display device including a forward field of view, the method comprising:
receiving a plurality of 3-dimensional (“3D”) models of the at least one physical object, at least some of the plurality of 3D models corresponding to configuration options for the at least one physical object;
receiving a first configuration for the at least one physical object, the first configuration including a first configuration price;
rendering a first virtual image of the at least one physical object based at least in part on the plurality of 3D models, the first virtual image being superimposed on the forward field of view of the head-mounted display device and corresponding to the first configuration, the first virtual image further including the first configuration price;
receiving at least one change to the first configuration to generate a second configuration;
determining an updated configuration price for the second configuration;
rendering a second virtual image of the at least one physical object based at least in part on the plurality of 3D models, the second virtual image being superimposed on the forward field of view of the head-mounted display device and corresponding to the second configuration, the second virtual image further including the updated configuration price; and
generating a final configuration based at least in part on a configuration selection, the final configuration forming a basis of a price quote for an instance of the at least one physical object configured according to the final configuration.

2. The method of claim 1, wherein each of the first virtual image and the second virtual image is rendered as one of a two-dimensional virtual image or a three-dimensional holographic virtual image.

3. The method of claim 1, wherein the first and second virtual images are superimposed on an instance of the at least one physical object present within the forward field of view of the head-mounted display device, thereby changing an apparent appearance of the instance of the at least one physical object.

4. The method of claim 1 further comprising:
interactively receiving a plurality of changes to the first configuration; and
for each of the plurality of changes to the first configuration, rendering an updated virtual image reflecting the respective one of the plurality of changes, the updated virtual image including an updated configuration price.

5. The method of claim 4 wherein interactively receiving a plurality of changes to the first configuration comprises:
receiving gesture data from the head-mounted display device or an input device associated therewith; and
identifying at least one of the plurality of changes to the first configuration based at least in part on an operation associated with a gesture corresponding to the gesture data.

6. The method of claim 1 wherein the plurality of 3D models is received from a configure, price, quote (CPQ) system.

7. The method of claim 6 wherein determining an updated configuration price for the second configuration comprises:
providing at least part of the second configuration to the CPQ system; and
receiving the updated configuration price from the CPQ system, the updated configuration price based at least in part on the second configuration.

8. A virtualized configuration system, comprising:
a head-mounted display device configured to provide a view of a virtual environment including at least one virtual image, the head-mounted display device including a plurality of sensors and a forward field of view;
a model database including a plurality of 3-dimensional (3D) models of at least one configurable physical object;
a configuration database including a plurality of configuration variations for the at least one configurable physical object, each of the plurality of configuration variations including pricing data for determining a price quote for an instance of the at least one configurable physical object that includes one or more of the plurality of configuration variations;
a configuration management component that comprises a virtualized configuration application programming interface (API) configured to provide access to the 3D models of the model database and the configuration variations of the configuration database; and
a virtualized configuration application component configured to:
receive via the virtualized configuration API the plurality of 3D models corresponding to the at least one configurable physical object;
receive via the virtualized configuration API a first configuration variation for the at least one configurable physical object, the first configuration variation including a first configuration price; and
render in the head-mounted display device a first virtual image of the at least one configurable physical object based at least in part on the plurality of 3D models corresponding to the first configuration variation, the first virtual image being superimposed on the forward field of view and including the first configuration price.

9. The virtualized configuration system of claim 8, wherein the configuration management component is further configured to generate a final configuration based at least in part on a final configuration selection, the final configuration forming a basis of a price quote for an instance of the at least one configurable physical object configured according to the final configuration.

10. The virtualized configuration system of claim 8, wherein the virtualized configuration application component is further configured to:
interactively receive at least one change to the first configuration variation to generate a second configuration variation;
determine via the virtualized configuration API an updated configuration price for the second configuration variation; and
render in the head-mounted display device an updated virtual image that reflects the at least one change, the updated virtual image including the updated configuration price.

11. The virtualized configuration system of claim 10 wherein the virtualized configuration application component is configured to interactively receive the at least one change to the first configuration variation by:
receiving gesture data from the head-mounted display device or an input device associated therewith;
identifying a gesture based at least in part on the gesture data; and
identifying the at least one change to the first configuration variation based at least in part on an operation associated with the identified gesture.

12. The virtualized configuration system of claim 10 wherein the first virtual image and the updated virtual image are superimposed on an instance of the at least one configurable physical object present within a physical environment visible in the forward field of view, thereby changing an apparent appearance of the instance of the at least one configurable physical object.

13. The virtualized configuration system of claim 10 wherein the first virtual image and the updated virtual image are each rendered as one of a two-dimensional virtual image or a three-dimensional holographic virtual image.

14. A head-mounted display device for virtual configuration of at least one physical object, comprising:
a display system including at least one display component configured to display virtual image content in a forward field of view;
a plurality of sensors;
one or more processors; and
one or more computer-readable storage media having stored thereon instructions, the instructions configured to, when executed by the one or more processors, cause the one or more processors to:
receive a plurality of 3-dimensional (“3D”) models of the at least one physical object, at least some of the plurality of 3D models corresponding to configuration options for the at least one physical object;
receive a first configuration for the at least one physical object, the first configuration including a first configuration price;
render on the at least one display component of the display system a first virtual image of the at least one physical object based at least in part on the plurality of 3D models, the first virtual image being superimposed on the forward field of view and corresponding to the first configuration, the first virtual image further including the first configuration price;
receive at least one change to the first configuration to generate a second configuration;
determine an updated configuration price for the second configuration;
render on the at least one display component of the display system a second virtual image of the at least one physical object based at least in part on the plurality of 3D models, the second virtual image being superimposed on the forward field of view and corresponding to the second configuration, the second virtual image further including the updated configuration price; and
generate a final configuration based at least in part on a configuration selection, the final configuration forming a basis of a price quote for an instance of the at least one physical object configured according to the final configuration.

15. The head-mounted display device of claim 14, wherein the instructions are further configured to, when executed by the one or more processors, cause the one or more processors to render each of the first and second virtual images as one of a two-dimensional virtual image or a three-dimensional holographic virtual image.

16. The head-mounted display device of claim 14, wherein the instructions are further configured to, when executed by the one or more processors, cause the one or more processors to superimpose the first and second virtual images on an instance of the at least one physical object present within the forward field of view of the head-mounted display device, thereby changing an apparent appearance of the instance of the at least one physical object.

17. The head-mounted display device of claim 14 wherein the instructions are further configured to, when executed by the one or more processors, cause the one or more processors to:
interactively receive a plurality of changes to the first configuration; and
for each of the plurality of changes to the first configuration, render an updated virtual image reflecting the respective one of the plurality of changes, the updated virtual image including an updated configuration price.

18. The head-mounted display device of claim 17 wherein the instructions are configured to, when executed by the one or more processors, cause the one or more processors to interactively receive the plurality of changes to the first configuration by:
receiving gesture data from the head-mounted display device or an input device associated therewith;
identifying a gesture based at least in part on the gesture data; and
identifying at least one of the plurality of changes to the first configuration based at least in part on an operation associated with the identified gesture.

19. The head-mounted display device of claim 14 wherein the plurality of 3D models is received from a configure, price, quote (CPQ) system.

20. The head-mounted display device of claim 19 wherein determining an updated configuration price for the second configuration comprises receiving the updated configuration price from the CPQ system, the updated configuration price based at least in part on the second configuration.
